(19) United States
(12) Patent Application Publication
(10) Pub. No.: US 2026/0260665 A1
(43) Pub. Date: Sep. 3, 2026

(54) SYSTEM AND METHOD FOR PREDICTIVE EDITORIAL SEQUENCING OF A DIRECTED VIDEO STREAM BASED ON TEMPORAL EVENT PHASE MODELLING

(71) Applicant: Vizi Inc.

(72) Inventors: Adam James Silver, Baiona (ES); William Bradshaw Pillow, Zionsville, IN (US)

(73) Assignee: Vizi Inc., (US)

(21) Appl. No.: 19/553,524

(22) Filed: Mar. 2, 2026

Related U.S. Application Data
(60) Provisional application No. 63/766,240, filed on Mar. 3, 2025.

(51) Int. Cl. G11B 27/031

(52) U.S. Cl. CPC G11B 27/031

(57) ABSTRACT

A system and method for predictive editorial sequencing of a directed video stream. A communication device receives candidate video streams captured by distributed camera devices. A computing platform determines, from the candidate video streams, a current temporal state of a real-world event by classifying the event into event phase classifications, and generates a temporal progression model predicting a forthcoming temporal state transition based on the current temporal state and historical phase progression data. The computing platform pre-determines transition windows derived from the temporal progression model, computes predicted narrative contribution scores for each candidate video stream representing alignment with the forthcoming temporal state, and generates a directed output video stream by selecting the candidate stream with the highest predicted narrative contribution score and executing transitions within the pre-determined transition windows.

### REFERENCE TO RELATED APPLICATIONS

This application claims the benefit of U.S. Provisional Patent Application No. 63/766,240, titled "AI VIDEO CLOUD SERVICE AND MULTI-CAMERA SYSTEM," filed on March 3, 2025, which is incorporated by reference herein in its entirety.

### TECHNICAL FIELD

The present disclosure relates generally to motion video signal processing for recording or reproducing. More particularly, the present disclosure relates to systems and methods for predictive editorial sequencing of a directed video stream.

### BACKGROUND

The proliferation of mobile devices and connected cameras has made it possible to capture a single real-world event simultaneously from a multitude of independent camera devices. In environments such as live sporting events, concerts, public gatherings, and collaborative performances, transforming these disparate video streams into a coherent and narratively meaningful directed output video stream remains a significant technical challenge.

Existing automated video switching systems address this challenge reactively – selecting streams based on present stream characteristics such as motion level, resolution, or instantaneous quality scores, or applying artificial intelligence techniques to rank and select streams based on evaluated visual or multimodal features. While such systems improve upon manual direction in terms of scalability, they share a fundamental limitation: they operate exclusively on the present state of candidate streams without any model of where the event is in its temporal progression or what narrative phase is approaching.

There exists a need for systems and methods for predictive editorial sequencing of a directed video stream.

### SUMMARY

The present disclosure provides a system and method for predictive editorial sequencing of a directed video stream based on temporal event phase modelling. In one aspect, a system is disclosed comprising a communication device configured to receive a plurality of candidate video streams from camera devices distributed across multiple locations, and a computing platform configured to determine a current temporal state of the real-world event from the received candidate video streams, generate a temporal progression model predicting a forthcoming temporal state transition, pre-determine one or more transition windows based on the temporal progression model, and generate a directed output video stream by selecting candidate video streams and executing transitions within the pre-determined transition windows.

In some embodiments, the current temporal state is determined by classifying the real-world event into one of a plurality of event phase classifications, including a build-up phase, a peak phase, and a resolution phase, based on temporal features extracted from the candidate video streams. In other embodiments, the temporal progression model is generated by applying a trained predictive model to the determined current temporal state and to historical event phase progression data, producing a predicted time-to-transition value and a predicted forthcoming phase. In further embodiments, the computing platform computes a predicted narrative contribution score for each candidate video stream representing the degree to which that stream is predicted to align with the forthcoming temporal state, and selects the candidate video stream having the highest predicted narrative contribution score for output within each transition window. The computing platform continuously updates the temporal progression model as the event progresses and recalculates transition windows upon detection of a deviation between the predicted and observed temporal state.

### BRIEF DESCRIPTION OF THE DRAWINGS

The following detailed description is provided to illustrate representative embodiments of the present disclosure and is not intended to limit the scope of the invention, which is defined by the appended claims. The embodiments described herein may be implemented in a variety of forms, and the disclosure is not limited to the specific embodiments, structures, or configurations described.

FIG. 1 is a block diagram illustrating a system for predictive editorial sequencing of a directed video stream from a plurality of distributed camera devices, in accordance with an embodiment of the present disclosure.

FIG. 2 is a block diagram illustrating functional modules of the computing platform of the system, in accordance with an embodiment of the present disclosure.

FIG. 3 is a block diagram illustrating internal components of the temporal state determination module and the temporal progression model generator, in accordance with an embodiment of the present disclosure.

FIG. 4 is a flowchart illustrating a method for predictive editorial sequencing of a directed video stream, in accordance with an embodiment of the present disclosure.

### DETAILED DESCRIPTION

The inventive contribution of the present disclosure lies in modelling the evolution of the real-world event over time and aligning stream selection decisions with anticipated narrative progression, rather than reacting to present stream characteristics. This anticipatory approach enables stream transitions to be pre-positioned at narratively optimal moments, preserving the editorial coherence and narrative continuity of the directed output video stream in a manner that reactive systems are structurally incapable of achieving.

As used herein, the singular forms "a," "an," and "the" include plural referents unless the context clearly indicates otherwise. The terms "comprising," "including," and "having" are used in an open-ended sense and do not exclude additional elements or steps not expressly recited. As used herein, the term "video stream" refers to a sequence of visual data captured over time by a camera device, whether continuous or segmented, and regardless of encoding format. The term "camera device" refers to any device capable of capturing visual data and generating a corresponding video stream, including mobile devices, fixed cameras, wearable cameras, or vehicle-mounted cameras. The term "candidate video stream" refers to any video stream received by the computing platform that is available for selection as part of the directed output video stream. The term "temporal state" refers to a classification of the real-world event into a recognized phase of its progression over time, representing where the event currently stands within its overall narrative arc. The term "temporal progression model" refers to a data structure or computational model maintained by the computing platform that represents the predicted future evolution of the real-world event from its current temporal state, including a predicted forthcoming temporal state and a predicted time-to-transition. The term "transition window" refers to a pre-determined interval of time during which the computing platform is authorized and prepared to execute a transition between candidate video streams, the interval being derived from the temporal progression model such that the transition is positioned to preserve narrative continuity of the directed output video stream. The term "narrative continuity" refers to the property of a directed output video stream whereby successive segments of the stream follow a coherent and editorially meaningful progression that reflects the natural arc of the real-world event being captured. The term "computing platform" refers to one or more computing devices comprising one or more processors and one or more non-transitory computer-readable memories storing instructions that, when executed, cause the computing platform to perform the operations described herein. Unless expressly stated otherwise, the steps of the methods described herein are not required to be performed in the order shown, and steps may be combined, omitted, or reordered consistent with the appended claims.

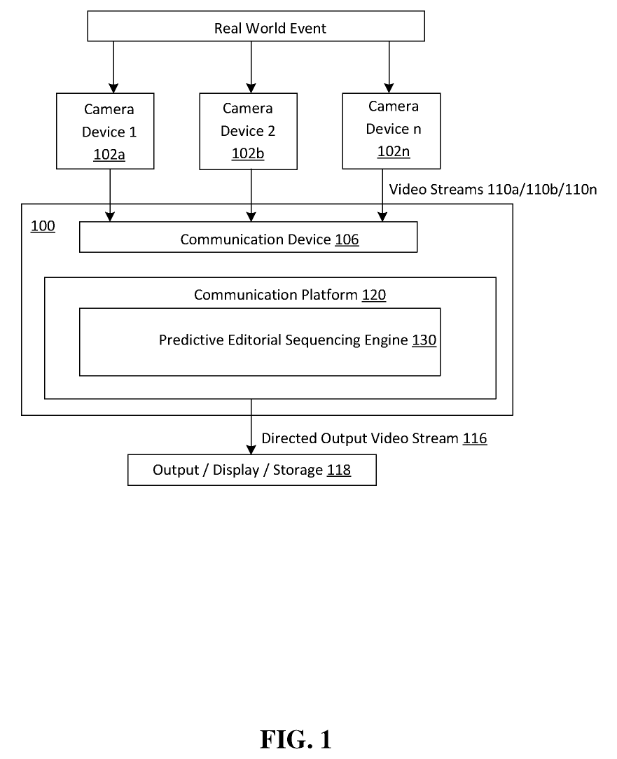

Referring to FIG. 1, a system 100 for predictive editorial sequencing of a directed video stream from distributed camera sources is illustrated. The system 100 is configured to receive candidate video streams captured by a plurality of camera devices distributed across multiple users, devices, or locations capturing a common real-world event, and to generate a directed output video stream based on predictive editorial sequencing decisions determined by a computing platform. In contrast to systems in which stream selection decisions are made reactively based on present stream characteristics, the system 100 operates anticipatorily - maintaining a model of the temporal progression of the real-world event, predicting forthcoming phase transitions, and pre-determining transition windows before those transitions occur.

The system 100 comprises a communication device 106 and a computing platform 120. A plurality of camera devices 102a-102n, shown individually as camera devices 102a, 102b, through 102n, which are external to the system 100., which are external to the system 100, are distributed across multiple locations and transmit candidate video streams 110a, 110b, through 110n to the communication device 106 via a communication network. The system 100 does not include the camera devices as claimed elements; rather, the system 100 receives the candidate video streams generated by those external devices. In some embodiments, the camera devices may be user-operated mobile devices such as smartphones or wearable cameras. In other embodiments, the camera devices may include fixed-position cameras, vehicle-mounted cameras, aerial cameras, or other capture devices deployed at different locations relative to the real-world occurrence. The camera devices operate independently with respect to capture, and the system 100 does not require the camera devices to be synchronized or configured in advance.

The real-world event captured by the plurality of camera devices may include any physical activity or occurrence that unfolds over time and is observable from multiple viewpoints, and that exhibits recognizable phases of temporal progression. Examples include live sporting events such as a football match, a track and field competition, or a swimming race; live performances such as a concert, a theatrical production, or a dance recital; public ceremonies such as a graduation, an award presentation, or a civic event; training exercises; emergency response scenarios; and collaborative activities. Because the camera devices are distributed, the resulting candidate video streams may differ in viewpoint, framing, timing, quality, and content, providing the system 100 with a diverse set of perspectives from which to construct the directed output video stream.

The communication device 106 is configured to receive the candidate video streams transmitted from the plurality of camera devices via the communication network. The communication network may include wired or wireless communication links and may comprise one or more networks, including local area networks, wide area networks, cellular networks, or the internet. The system 100 does not require a specific network topology or protocol.

The computing platform 120 receives the candidate video streams transmitted from the plurality of camera devices via the communication device 106. The computing platform comprises one or more processors and a non-transitory computer-readable memory storing instructions that, when executed, cause the computing platform to perform the predictive editorial sequencing operations described herein. The computing platform may be implemented on a mobile device, an edge or base station, a cloud-based computing system, or a distributed combination thereof, depending on deployment requirements. In some embodiments, certain operations of the computing platform, such as initial temporal feature extraction, are performed at an edge node proximate to the camera devices, while other operations, such as training and updating the temporal progression model, are performed on a cloud-based system with greater computational resources. In other embodiments, all operations are performed on a single cloud-based computing system that receives candidate video streams from all camera devices via the internet. The computing platform 120 receives the candidate video streams transmitted from the plurality of camera devices via the communication device 106. The computing platform comprises one or more processors and a non-transitory computer-readable memory storing instructions that, when executed, cause the computing platform to perform the predictive editorial sequencing operations described herein. The computing platform 120 includes a predictive editorial sequencing engine 130 that implements the anticipatory temporal state determination, temporal progression modelling, transition window pre-determination, and directed output generation operations described herein, and that distinguishes the computing platform from systems that perform reactive stream selection based solely on present stream characteristics. The computing platform may be implemented on a mobile device, an edge or base station, a cloud-based computing system, or a distributed combination thereof, depending on deployment requirements. In some embodiments, certain operations of the computing platform, such as initial temporal feature extraction, are performed at an edge node proximate to the camera devices, while other operations, such as training and updating the temporal progression model, are performed on a cloud-based system with greater computational resources. In other embodiments, all operations are performed on a single cloud-based computing system that receives candidate video streams from all camera devices via the internet.

Based on the predictive editorial sequencing decisions determined by the computing platform, the system 100 generates a directed output video stream 116. The directed output video stream represents a selected and ordered presentation of video content derived from the plurality of received candidate video streams, wherein transitions between candidate video streams are executed within pre-determined transition windows that are aligned with the anticipated narrative arc of the real-world event. The directed output video stream may be generated during capture of the real-world event or after capture, and may be provided to an output, storage, or display system 118 for viewing, distribution, or archival storage.

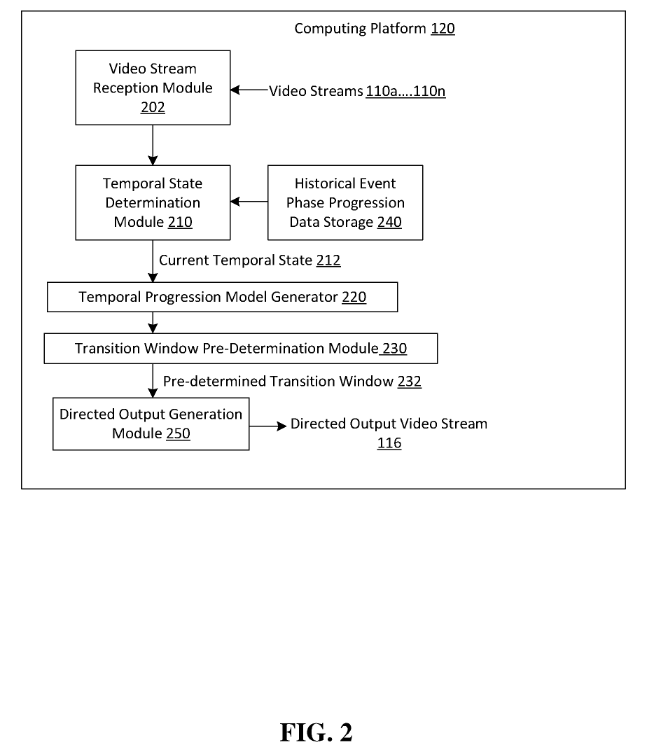

Referring to FIG. 2, the computing platform 120 includes a set of functional modules that collectively implement the predictive editorial sequencing operations. These modules may be implemented as software modules executing on one or more processors, as dedicated hardware components, as firmware, or as any combination thereof. The modules communicate via internal data interfaces and operate in a coordinated pipeline that transforms received candidate video streams into a directed output video stream.

The computing platform 120 includes a video stream reception module 202 configured to receive candidate video streams 204 transmitted from the plurality of camera devices via the communication network. Each received candidate video stream corresponds to visual data captured by a respective camera device from a particular viewpoint of the real-world event. In some embodiments, the video stream reception module 202 temporarily buffers received candidate video streams to accommodate variations in arrival time or network conditions, ensuring that a consistent and synchronized set of candidate streams is available for analysis at each processing cycle. The buffer duration may be adaptively adjusted based on observed network latency and jitter across the plurality of camera devices.

The computing platform 120 further includes a temporal state determination module 210 configured to analyze the received candidate video streams 204 and determine a current temporal state 212 of the real-world event. The current temporal state represents a classification of the event into one of a plurality of event phase classifications, each representing a recognizable stage in the progression of the event over time. The temporal state determination module 210 operates on temporal features extracted from the candidate video streams over an analysis window, rather than on instantaneous frame-level characteristics, enabling it to assess the trajectory of the event rather than merely its present condition.

The computing platform 120 further includes a temporal progression model generator 220 configured to receive the current temporal state 212 determined by the temporal state determination module 210 and to generate a temporal progression model 222. The temporal progression model represents the predicted future evolution of the real-world event from its current temporal state, including a predicted forthcoming temporal state and a predicted time-to-transition representing the estimated duration until the next phase transition. The temporal progression model generator 220 applies a trained predictive model to the current temporal state in conjunction with historical event phase progression data retrieved from a historical event phase progression data store 240.

The computing platform 120 further includes a transition window pre-determination module 230 configured to receive the temporal progression model 222 and to pre-determine one or more transition windows 232. Each transition window defines a time interval during which the computing platform is authorized and prepared to execute a transition between candidate video streams, the interval being centered on or preceding the predicted time-to-transition such that the transition is executed before the forthcoming temporal state transition occurs. The transition window pre-determination module 230 also receives predicted narrative contribution scores computed for each candidate video stream, and identifies the candidate video stream having the highest predicted narrative contribution score for selection within each transition window.

The computing platform 120 further includes a directed output generation module 250 configured to receive the pre-determined transition windows 232 and the candidate video stream selections associated therewith, and to generate the directed output video stream 116 by assembling segments of selected candidate video streams and executing transitions between those segments within the pre-determined transition windows. In some embodiments, the directed output generation module 250 applies video processing operations to the assembled segments prior to output, including resolution normalization, frame rate harmonization, color correction, and audio level matching, to ensure that the directed output video stream presents a visually consistent and technically uniform output regardless of the heterogeneous characteristics of the individual candidate video streams.

The computing platform 120 further includes a model update and correction module 225 configured to continuously monitor the alignment between the temporal progression model 222 and the observed progression of the real-world event as reflected in the candidate video streams. When the model update and correction module 225 detects a deviation between the predicted forthcoming temporal state and the determined current temporal state that exceeds a predefined threshold, it triggers a recalculation of the temporal progression model and a corresponding recalculation of the pre-determined transition windows. This closed-loop correction mechanism ensures that the temporal progression model remains aligned with the actual progression of the event even when the event deviates from its anticipated trajectory.

The historical event phase progression data store 240 stores historical data representing the phase progression patterns of previously observed real-world events of the same or similar event type as the current real-world event. This data includes phase duration statistics representing the typical duration of each event phase classification for a given event type, phase sequence patterns representing the typical order and frequency of phase transitions for a given event type, and phase feature signatures representing the typical temporal feature values observed during each phase classification. The historical event phase progression data store 240 is populated during a training phase in which a corpus of previously recorded events is analyzed and annotated with phase classifications, and is updated over time as additional events are processed by the system.

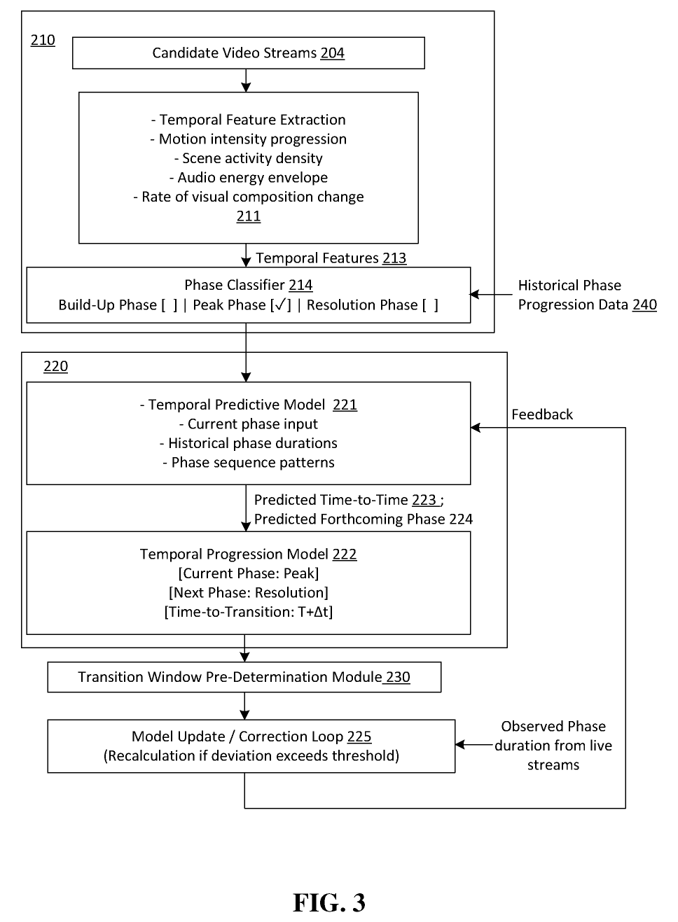

Referring to FIG. 3, the temporal state determination module 210 operates on the received candidate video streams 204 to determine the current temporal state 212 of the real-world event. The determination of the current temporal state is a multi-stage process comprising temporal feature extraction, phase classification, and confidence scoring, each of which is described in detail below.

The temporal state determination module 210 includes a temporal feature extraction submodule 211 configured to extract a set of temporal features 213 from the candidate video streams over a temporal analysis window. The temporal analysis window defines the duration of the video data over which temporal features are computed and may range from a few seconds to several minutes, depending on the event type and the granularity of phase classification required. In some embodiments, the temporal analysis window is a sliding window that advances in real time as new video data is received, enabling continuous updating of the extracted temporal features without requiring the analysis to restart from the beginning of the event. In other embodiments, the temporal analysis window is an expanding window that grows from the beginning of the event until a predefined maximum window size is reached, after which it transitions to a sliding window of fixed duration.

The temporal features extracted by the temporal feature extraction submodule 211 include, but are not limited to, the following. Motion intensity progression represents the rate of change of motion activity across the candidate video streams over the temporal analysis window, computed by aggregating optical flow magnitudes or frame difference metrics across frames within the window and measuring the slope and curvature of the resulting motion intensity time series. A rising motion intensity progression is characteristic of a build-up phase, a sustained high motion intensity is characteristic of a peak phase, and a declining motion intensity progression is characteristic of a resolution phase. Scene activity density represents the spatial density of detected moving objects or regions of interest within the frames of the candidate video streams, computed by applying object detection or foreground segmentation algorithms to sampled frames and measuring the proportion of the frame area occupied by detected activity. Audio energy envelope represents the time-varying amplitude of audio signals associated with the candidate video streams, computed by extracting the root mean square energy of audio frames over the temporal analysis window and measuring the shape of the resulting envelope. Rate of change of visual composition represents the degree to which the dominant visual elements within the candidate video streams are changing over the temporal analysis window, computed by measuring the rate of change of low-level visual features such as color histograms, edge density, and spatial frequency content across frames within the window.

In some embodiments, the temporal feature extraction submodule 211 extracts temporal features independently from each candidate video stream and then aggregates the per-stream features into a single set of event-level temporal features representing the overall state of the event as observed across all available perspectives. The aggregation may be performed by computing the mean, maximum, or weighted combination of the per-stream feature values, where the weights reflect the reliability or quality of each candidate video stream.

To illustrate temporal feature extraction with a concrete example, consider a system processing candidate video streams from a football match. At a point in the match where a team is building an attacking play toward the opposing goal, the motion intensity progression computed over a thirty-second analysis window shows a rising slope, the scene activity density shows an increasing proportion of the frame occupied by players converging toward the penalty area, the audio energy envelope shows rising crowd noise, and the rate of change of visual composition shows increasing variation as players and the ball move rapidly across the frame. These temporal features collectively characterize the current moment as a build-up phase in the match's progression. Contrast this with a point in the match immediately following a goal, where motion intensity has spiked and is now declining, scene activity density is decreasing as players return to their starting positions, audio energy has reached a maximum and is beginning to fall, and visual composition is stabilizing. These features collectively characterize the current moment as the beginning of a resolution phase following the peak of the scoring event.

The temporal state determination module 210 includes a phase classifier 214 configured to receive the extracted temporal features 213 and classify the real-world event into one of a plurality of event phase classifications representing the current temporal state 212. In some embodiments, the plurality of event phase classifications comprises at least a build-up phase, a peak phase, and a resolution phase. The build-up phase represents a period during which event activity is increasing in intensity, complexity, or significance, and the event is progressing toward a moment of peak action or significance. The peak phase represents the moment or period of highest activity, intensity, or significance within the current narrative segment of the event, during which the most editorially important action is occurring. The resolution phase represents the period following the peak during which activity is decreasing, the consequences of the peak action are becoming apparent, and the event is transitioning toward either a new build-up phase or a conclusion.

In some embodiments, the plurality of event phase classifications further comprises one or more intermediate phase classifications representing transitional stages between adjacent primary phases. For example, an intermediate phase classification may represent a pre-peak phase during which the build-up has reached a high level of intensity and the peak is imminent, or a post-peak phase during which the peak action has just concluded and the resolution is beginning. The inclusion of intermediate phase classifications increases the resolution of the temporal state determination and enables more precise pre-determination of transition windows, particularly in event types where primary phase transitions occur rapidly and the window for anticipatory stream selection is narrow.

The phase classifier 214 may be implemented as a trained machine learning classifier, such as a recurrent neural network, a long short-term memory network, a transformer-based sequence classifier, or a hidden Markov model, that receives the extracted temporal features as input and outputs a probability distribution over the plurality of event phase classifications. The current temporal state is determined as the phase classification having the highest probability in the output distribution. In some embodiments, the phase classifier 214 also outputs a confidence score representing the certainty of the classification, and the computing platform uses this confidence score to modulate the aggressiveness of transition window pre-determination - a low confidence score may cause the computing platform to widen the pre-determined transition windows to accommodate uncertainty in the phase boundary, while a high confidence score enables tighter and more precisely timed transition windows.

To continue the football match example, the phase classifier 214 receives the temporal features extracted during the attacking build-up and outputs a probability distribution in which the build-up phase has a probability of 0.78, the pre-peak intermediate phase has a probability of 0.17, and all other phases have probabilities below 0.05. The current temporal state is therefore determined to be the build-up phase with a confidence score of 0.78. The computing platform uses this determination to initiate the generation of a temporal progression model predicting the forthcoming transition to a peak phase.

The temporal progression model generator 220 receives the current temporal state 212 determined by the temporal state determination module 210 and generates a temporal progression model 222 representing the predicted future evolution of the real-world event. The temporal progression model generator 220 applies a trained predictive model 221 to the current temporal state in conjunction with historical event phase progression data retrieved from the historical event phase progression data store 240.

The trained predictive model 221 receives as input the current temporal state, the duration for which the event has been in the current temporal state as observed from the candidate video streams, the sequence of temporal states that have preceded the current state since the beginning of the event, and the historical phase duration statistics and phase sequence patterns retrieved from the data store 240 for the current event type. Based on these inputs, the trained predictive model 221 outputs a predicted time-to-transition value 223 representing the estimated duration until the next temporal state transition, and a predicted forthcoming temporal state 224 representing the phase classification into which the event is predicted to transition.

The predicted time-to-transition value is expressed as a probability distribution over time rather than a single point estimate, reflecting the inherent uncertainty in predicting the precise moment of a phase transition in a live event. The distribution may be represented as a mean predicted time-to-transition with an associated standard deviation, or as a full probability density function over a time horizon. The width of the distribution reflects the historical variability of phase durations for the current event type and phase.

The temporal progression model 222 produced by the temporal progression model generator 220 comprises the current temporal state, the predicted forthcoming temporal state, the predicted time-to-transition probability distribution, and a predicted phase sequence representing the expected succession of phase classifications over a lookahead horizon extending beyond the immediately forthcoming transition. The lookahead horizon may extend one, two, or more phase transitions into the future, enabling the computing platform to pre-determine transition windows not only for the immediately forthcoming phase transition but for subsequent transitions as well.

To continue the football match example, the temporal progression model generator 220 receives the current temporal state of build-up phase, observes that the event has been in the build-up phase for approximately eighteen seconds, and retrieves historical phase duration statistics for professional football build-up phases from the data store 240 showing a mean build-up phase duration of thirty-eight seconds with a standard deviation of twelve seconds. Given that the build-up phase has already been in progress for twenty-three seconds, the remaining predicted time-to-transition is fifteen seconds with a standard deviation of eight seconds. The predicted forthcoming temporal state is the peak phase. The temporal progression model, therefore, indicates that the peak phase of the current attacking play is expected to occur approximately fifteen seconds from now, with a range of seven to twenty-three seconds representing the one-standard-deviation confidence interval.

The historical event phase progression data store 240 stores structured data representing the phase progression patterns of previously observed real-world events. For each event type represented in the data store, the stored data includes phase duration statistics comprising the mean, standard deviation, minimum, and maximum observed duration of each phase classification across the corpus of historical events of that type; phase sequence patterns comprising the conditional probability of each possible successor phase given the current phase; phase feature signatures comprising the typical temporal feature values observed during each phase classification for a given event type; and event-level phase progression templates representing the typical overall phase sequence for a complete instance of the event type, from initiation to conclusion.

In some embodiments, the historical event phase progression data store 240 is organized hierarchically by event category, event type, and event subtype, enabling the computing platform to retrieve phase progression data at the appropriate level of specificity for the current event. For example, a football match may be represented at the event category level as a team sport, at the event type level as association football, and at the event subtype level as a professional league match, enabling the computing platform to retrieve phase progression statistics that reflect the specific characteristics of professional league football rather than applying generic team sport statistics.

In some embodiments, the historical event phase progression data store 240 is updated in real time as the current event progresses, incorporating observations from the current event into the stored statistics using an online learning mechanism. This enables the computing platform to adapt the temporal progression model to the specific characteristics of the current event instance as they become apparent during the event, supplementing the prior statistics from historical events with event-specific observations that may reveal deviations from the historical norm.

The transition window pre-determination module 230 receives the temporal progression model 222 and pre-determines one or more transition windows 232 during which the computing platform is authorized and prepared to execute a transition between candidate video streams. The pre-determination of transition windows is a distinctly anticipatory operation - the transition windows are computed before the forthcoming temporal state transition occurs, based on the predicted time-to-transition and the predicted forthcoming temporal state, rather than being triggered by the detection of a transition that is already underway. This anticipatory characteristic is what fundamentally distinguishes the present system from reactive stream selection systems, and it is the foundation upon which narrative continuity of the directed output video stream is preserved.

The transition window pre-determination module 230 computes each transition window as a time interval defined by a window start time and a window end time relative to the current moment. The window start time and window end time are derived from the predicted time-to-transition probability distribution contained in the temporal progression model 222. In one embodiment, the window start time is set to the predicted time-to-transition mean minus one standard deviation, and the window end time is set to the predicted time-to-transition mean plus one standard deviation, such that the transition window spans the one-standard-deviation confidence interval of the predicted phase transition. In another embodiment, the window start time is set to a fixed offset before the predicted time-to-transition mean, such that the transition is always executed slightly in advance of the predicted phase transition, ensuring that the directed output video stream has already transitioned to the optimal candidate stream before the peak action begins rather than during it.

The width of the transition window is adaptively modulated based on the confidence score output by the phase classifier 214. When the confidence score is high, the transition window is narrowed to concentrate the transition at the most probable moment of phase change. When the confidence score is low, the transition window is widened to accommodate the possibility that the phase transition may occur earlier or later than predicted.

To illustrate transition window pre-determination with a concrete example, consider a live concert scenario in which the system is processing candidate video streams from multiple cameras within the venue - a wide-angle stage overview camera, a close-up performer camera, a crowd-facing camera, and several audience-operated mobile device cameras. The temporal progression model has determined that the event is currently in a build-up phase as the performer approaches the climax of a song, with a predicted time-to-transition to the peak phase of fifteen seconds and a standard deviation of five seconds. The transition window pre-determination module computes a transition window starting at ten seconds from now and ending at twenty seconds from now. Within this window, the computing platform will execute a transition from the currently output wide-angle stage overview stream to whichever candidate stream has been identified as having the highest predicted narrative contribution score for the forthcoming peak phase.

The transition window pre-determination module 230 further comprises a narrative contribution scoring submodule configured to compute, for each candidate video stream, a predicted narrative contribution score representing the degree to which that candidate video stream is predicted to align with the forthcoming temporal state. The predicted narrative contribution score is computed in advance of the transition window, enabling the computing platform to identify the optimal candidate stream before the window opens.

The predicted narrative contribution score for each candidate video stream is computed based on a plurality of predictive indicators. Predicted motion trajectory represents the anticipated future motion content of the candidate video stream based on the current motion trajectory of subjects or objects visible in that stream, computed by applying motion prediction algorithms such as Kalman filtering, optical flow extrapolation, or learned trajectory prediction models to the recent motion history of visible subjects. Predicted scene composition change represents the anticipated degree to which the visual composition of the candidate stream will change between the current moment and the forthcoming phase. Predicted proximity to anticipated focal point represents the estimated spatial relationship between the primary subjects visible in the candidate stream and the anticipated focal point of the forthcoming phase of the event - for a football match in a peak phase, the anticipated focal point is the goal mouth and the area immediately surrounding it; for a concert in a peak phase, the anticipated focal point is the lead performer at the moment of the climax.

In some embodiments, the narrative contribution score further incorporates a stream quality component representing the technical quality of the candidate video stream, including resolution, bitrate, frame rate continuity, and network stability, serving as a tiebreaker among equally well-positioned streams. In some embodiments, the narrative contribution score further incorporates a contextual redundancy penalty applied to candidate streams whose predicted content during the forthcoming phase is determined to be substantially similar to the content of the currently output stream, avoiding transitions that would not provide meaningful new narrative information to the viewer.

The overall predicted narrative contribution score for each candidate video stream is computed as a weighted combination of the individual predictive indicator scores, where the weights reflect the relative importance of each indicator for the current event type and forthcoming phase. During a forthcoming peak phase in a sporting event, the predicted proximity to the anticipated focal point and predicted motion trajectory indicators are weighted most heavily. During a forthcoming resolution phase, the stream quality component and contextual redundancy penalty may be weighted more heavily.

To illustrate narrative contribution scoring in the concert scenario, for the forthcoming peak phase, the narrative contribution scoring submodule computes the following scores. The wide-angle stage overview stream currently being output receives an overall narrative contribution score of 0.54. The close-up performer stream receives a score of 0.89, driven by high predicted motion trajectory, high predicted scene composition change, and high predicted proximity as the performer is the primary focal point. The crowd-facing stream receives a score of 0.71 for the resolution phase following the peak, based on the anticipated crowd reaction. The audience mobile device streams receive scores below 0.50 and are suppressed as contextually redundant. The transition window pre-determination module, therefore, identifies the close-up performer stream as the optimal selection for output during the forthcoming peak phase.

Prior to the opening of a pre-determined transition window, the transition window pre-determination module 230 performs a contextual redundancy suppression operation in which candidate video streams whose predicted content during the forthcoming phase is determined to be contextually redundant relative to the currently output stream are suppressed from consideration as transition targets. A candidate stream is determined to be contextually redundant if its predicted narrative contribution score falls below a predefined redundancy threshold, or if its predicted content similarity to the currently output stream exceeds a predefined similarity threshold.

In some embodiments, suppressed streams are not permanently excluded from consideration but are re-evaluated at each processing cycle, enabling them to be reinstated as candidates if their predicted narrative contribution improves as the event progresses. For example, an audience mobile device stream that is currently suppressed due to low predicted proximity to the focal point may be reinstated as a candidate if the device operator moves toward the focal point and the predicted proximity score increases accordingly.

The directed output generation module 250 monitors the progress of the real-world event against the temporal progression model and executes stream transitions within the pre-determined transition windows. When the current time falls within a pre-determined transition window, the directed output generation module 250 executes a transition from the currently output candidate stream to the selected candidate stream having the highest predicted narrative contribution score.

The timing of the transition within the transition window is further refined by the directed output generation module 250 based on real-time monitoring of the candidate streams for natural transition points - moments within the transition window at which a transition can be executed with minimal visual disruption. Natural transition points include moments of low motion activity in the currently output stream, moments of visual occlusion, moments of camera movement that naturally redirect the viewer's attention, and moments of audio continuity that provide a natural bridge between the outgoing and incoming streams. The transition is executed as a cut, a dissolve, or a cross-fade depending on the nature of the transition and the editorial context, with cuts preferred for transitions at moments of high action and dissolves or cross-fades preferred for transitions at moments of lower activity.

In some embodiments, when no natural transition point is detected within the transition window before the window closes, the directed output generation module 250 executes the transition at the end of the transition window using a dissolve or cross-fade effect to minimize visual disruption. In other embodiments, the directed output generation module 250 extends the transition window by a predefined grace period to allow additional time for a natural transition point to be detected, provided that the extension does not cause the transition to be executed after the predicted phase transition has already occurred.

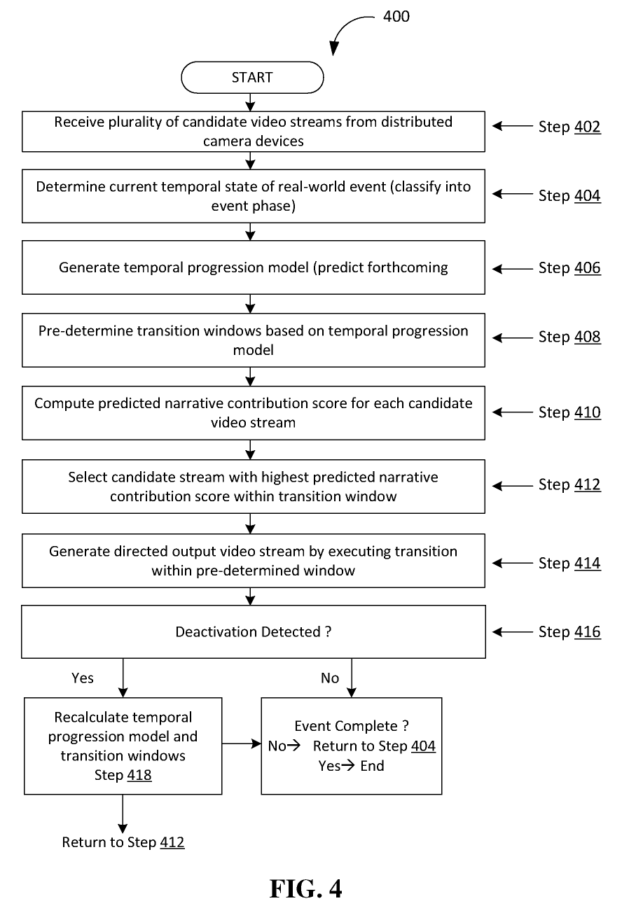

Referring to FIG. 4, a method 400 for predictive editorial sequencing of a directed video stream is illustrated. The method 400 is performed by the computing platform 120 and comprises the steps described below. The steps are described in the order shown in FIG. 4 for clarity of exposition, but are not required to be performed in that order unless expressly stated, and certain steps may be performed concurrently, iteratively, or in a different sequence consistent with the appended claims.

At step 402 of the method 400, the computing platform 120 receives a plurality of candidate video streams transmitted from a plurality of camera devices distributed across multiple locations. The candidate video streams are received via the communication device 106 and the communication network, and are buffered by the video stream reception module 202 to accommodate variations in network latency and transmission timing across the distributed camera devices. Each received candidate video stream is associated with metadata identifying the source camera device, the timestamp of capture, and available stream quality metrics including resolution, frame rate, and bitrate.

At step 404 of the method 400, the computing platform 120 determines a current temporal state of the real-world event from analysis of the plurality of candidate video streams. The temporal state determination module 210 extracts temporal features from the candidate video streams over a temporal analysis window using the temporal feature extraction submodule 211, and applies the phase classifier 214 to classify the real-world event into one of the plurality of event phase classifications. The current temporal state is output as the phase classification having the highest probability in the classifier output distribution, together with an associated confidence score. Step 404 is performed continuously and iteratively as new video data is received. In some embodiments, step 404 further comprises receiving and analyzing one or more non-visual signals associated with the real-world event, including audio signals and telemetry data, as described in detail below.

At step 406 of the method 400, the computing platform 120 generates a temporal progression model predicting a forthcoming temporal state transition of the real-world event based on the current temporal state determined at step 404. The temporal progression model generator 220 applies the trained predictive model 221 to the current temporal state, the observed duration of the current state, the sequence of preceding states, and historical event phase progression data retrieved from the data store 240, producing a temporal progression model 222 comprising the predicted forthcoming temporal state, the predicted time-to-transition probability distribution, and the predicted phase sequence over the lookahead horizon. Step 406 is performed each time the current temporal state is updated at step 404.

At step 408 of the method 400, the computing platform 120 pre-determines one or more transition windows based on the temporal progression model generated at step 406. The transition window pre-determination module 230 computes each transition window as a time interval derived from the predicted time-to-transition probability distribution, with the window boundaries modulated by the confidence score of the current temporal state determination. The pre-determined transition windows 232 are output as a schedule of time intervals during which the computing platform is authorized and prepared to execute stream transitions.

At step 410 of the method 400, the computing platform 120 computes a predicted narrative contribution score for each candidate video stream. The narrative contribution scoring submodule evaluates each candidate stream against the predictive indicators - predicted motion trajectory, predicted scene composition change, predicted proximity to anticipated focal point, stream quality, and contextual redundancy - and computes an overall weighted narrative contribution score for each stream. Candidate streams determined to be contextually redundant are suppressed from further consideration. Step 410 is performed sufficiently in advance of the opening of the pre-determined transition window to ensure that the stream selection decision is ready before the window opens.

At step 412 of the method 400, the computing platform 120 selects, from the non-suppressed candidate video streams, the stream having the highest predicted narrative contribution score for output within the forthcoming transition window. In some embodiments, a ranked list of candidate streams is maintained rather than a single selection, enabling the directed output generation module 250 to fall back to the second-ranked stream if the top-ranked stream becomes unavailable or its quality degrades before the transition is executed.

At step 414 of the method 400, the computing platform 120 generates the directed output video stream by executing a transition from the currently output candidate stream to the selected candidate stream within the pre-determined transition window. The directed output generation module 250 monitors the candidate streams in real time during the transition window to identify natural transition points, and executes the transition at the most suitable natural transition point within the window.

At step 416 of the method 400, the computing platform 120 evaluates whether a deviation exists between the predicted forthcoming temporal state contained in the temporal progression model and the current temporal state as currently determined from the candidate video streams. The model update and correction module 225 performs this evaluation continuously by comparing the predicted phase duration derived from the temporal progression model against the observed phase duration computed from the candidate video streams. A deviation is detected when the difference between the predicted phase duration and the observed phase duration exceeds a predefined deviation threshold, which may be expressed as an absolute time difference or as a proportion of the predicted phase duration. When no deviation is detected, the method proceeds to assess whether the event has concluded, returning to step 404 if not.

At step 418 of the method 400, when a deviation is detected, the computing platform 120 recalculates the temporal progression model and the pre-determined transition windows. The model update and correction module 225 triggers the temporal progression model generator 220 to regenerate the temporal progression model using the updated current temporal state and the updated observed phase duration as inputs. The transition window pre-determination module 230 then recalculates the pre-determined transition windows based on the recalculated temporal progression model, and the narrative contribution scores are recomputed for the updated windows. Following recalculation, the method returns to step 412 to re-evaluate the stream selection.

The model recalculation mechanism at step 418 provides the system with a closed-loop correction capability that enables it to remain aligned with the actual progression of the event even when the event deviates significantly from its anticipated trajectory. For example, if a football match enters an unexpected period of extended build-up due to a tactical substitution or an injury stoppage, the observed phase duration will exceed the predicted phase duration, triggering a deviation detection at step 416 and a model recalculation at step 418 that extends the predicted time-to-transition accordingly.

In some embodiments, the temporal state determination module 210 integrates non-visual signals into the temporal state determination process at step 404, supplementing the visual temporal features extracted from the candidate video streams with additional evidence bearing on the current phase of the real-world event.

Audio signals associated with the real-world event are received by the computing platform 120 in conjunction with the candidate video streams, either as audio tracks embedded within the video streams or as separate audio feeds from dedicated microphones or audio capture devices deployed at the event venue. The temporal state determination module 210 processes audio signals to extract audio temporal features including the audio energy envelope, spectral features such as the dominant frequency content of the audio signal, the rate of change of audio energy, the presence and intensity of crowd chanting or sustained vocalization, the temporal pattern of impact sounds in sporting events, and the cadence and intensity of musical performance in concert scenarios. In event types such as sporting events or concerts, the audio energy envelope provides a strong signal of phase progression, as crowd noise, commentary intensity, and performance audio typically follow recognizable patterns that correlate with event phases.

Telemetry data associated with the real-world event is received by the computing platform 120 from telemetry sources deployed at the event, including positional tracking systems that report the real-time position and velocity of players, performers, vehicles, or other primary subjects; biometric monitoring systems that report physiological data such as heart rate, exertion level, or stress indicators for participants; equipment sensors that report the state or movement of event-specific objects such as a ball, a puck, or a baton; and infrastructure sensors that report the state of event venue systems. Telemetry data provides a high-fidelity, low-latency signal of event phase progression that complements the visual and audio signals derived from the candidate video streams. In particular, positional telemetry data from player tracking systems in sporting events can provide highly accurate predictions of imminent peak action - for example, the convergence of multiple players toward the goal mouth at high velocity is a strong predictor of an imminent shooting event, enabling the temporal progression model to predict the forthcoming peak phase with greater precision and narrower time-to-transition uncertainty than would be achievable from visual analysis alone.

The temporal state determination module 210 integrates visual temporal features, audio temporal features, and telemetry features into a unified feature vector that is presented to the phase classifier 214. In some embodiments, the relative weighting of visual, audio, and telemetry features in the unified feature vector is adaptively adjusted based on the availability and reliability of each signal type - if telemetry data is unavailable for a particular event, the weighting of visual and audio features is increased to compensate, and the phase classifier operates on the reduced feature set without degradation of the classification architecture.

To illustrate the complete operation of the method 400, consider a system processing candidate video streams from a professional football match. The system receives eight candidate video streams: a wide-angle broadcast overview camera positioned at the halfway line at an elevated position; a tight follow camera tracking the ball and surrounding players; a goal mouth camera positioned behind the goal at the attacking end; a player close-up camera providing tight framing of individual player actions; a stadium atmosphere camera directed at the crowd; a referee tracking camera; and two audience mobile device streams transmitted by spectators in the stands.

At a point sixty-seven minutes into the match, the temporal state determination module 210 is processing the candidate video streams over a thirty-second sliding analysis window. The extracted temporal features show a rising motion intensity progression as players advance toward the opposing penalty area, an increasing scene activity density as multiple players converge in the attacking third of the pitch, a rising audio energy envelope reflecting increasing crowd noise and commentary intensity, and a high rate of change of visual composition. The positional telemetry data from the player tracking system shows three attacking players converging on the penalty area at velocities between four and seven meters per second, with the ball-carrying player approaching the edge of the penalty area. The phase classifier 214 outputs a probability distribution assigning 0.82 to the build-up phase and 0.14 to the pre-peak intermediate phase. The current temporal state is determined to be the build-up phase with a confidence score of 0.82.

The temporal progression model generator 220 applies the trained predictive model 221, observing that the build-up phase has been in progress for approximately twenty-three seconds and retrieving historical phase duration statistics showing a mean build-up phase duration of thirty-eight seconds with a standard deviation of twelve seconds. The remaining predicted time-to-transition is fifteen seconds with a standard deviation of eight seconds. The predicted forthcoming temporal state is the peak phase.

The transition window pre-determination module 230 computes a transition window opening seven seconds from now and closing twenty-three seconds from now. The narrative contribution scoring submodule computes predicted narrative contribution scores: the goal mouth camera receives 0.91, driven by high predicted proximity reflecting the telemetry data showing attacking players converging on the goal mouth; the tight follow camera receives 0.83; the player close-up camera receives 0.74; the wide-angle overview currently being output receives 0.61; and the two audience mobile device streams receive 0.38 and 0.29 and are suppressed. The goal mouth camera is selected as the transition target.

Eight seconds from now, the transition window opens. The directed output generation module 250 monitors the current output wide-angle overview stream for a natural transition point. At eleven seconds from now, the ball-carrying player executes a pass that momentarily takes the ball out of frame - a natural transition point. The directed output generation module 250 executes a cut transition to the goal mouth camera at this moment. Two seconds later, at thirteen seconds from now, the attacking player receives the pass inside the penalty area and shoots toward goal - the peak phase of the current narrative segment. Because the transition to the goal mouth camera was executed two seconds before the shot, the directed output video stream captures the shot from the optimal camera position, with the transition having been executed smoothly at a natural transition point rather than reactively at the moment of the shot itself.

Following the resolution of the peak action, the temporal state determination module 210 detects a transition to the resolution phase based on declining motion intensity, decreasing scene activity density, and falling audio energy. The temporal progression model is updated, and the transition window pre-determination module pre-determines a new transition window for the forthcoming transition from the resolution phase to the next build-up phase, selecting the stadium atmosphere camera as the optimal output stream for the resolution phase based on its high predicted narrative contribution score for capturing the crowd reaction.

Consider a system processing candidate video streams from a live concert performance. The system receives six candidate streams: a wide-angle stage overview camera at the front-of-house position; a lead performer close-up camera; a band wide shot camera showing all performers; a crowd-facing camera at the rear of the stage; a roving handheld camera in the audience; and a static elevated camera in the upper balcony.

The concert is forty minutes into the performance, and the current song is approaching its final chorus. The temporal state determination module 210 extracts temporal features showing rising audio energy driven by increasing vocal intensity and instrumental volume, rising motion intensity reflecting the performer's increasing physical expressiveness, and a high rate of change in audio spectral content as the arrangement builds. The phase classifier 214 classifies the current temporal state as the build-up phase with a confidence score of 0.86.

The trained predictive model 221 retrieves historical phase progression data for live concert performances of this genre, showing that final chorus build-up phases typically last between twelve and twenty-five seconds. The predicted time-to-transition is eighteen seconds with a standard deviation of six seconds. The pre-determined transition window opens at twelve seconds from now and closes at twenty-four seconds from now.

The narrative contribution scoring submodule computes predicted scores: the lead performer close-up camera receives 0.93, driven by high predicted proximity to the focal point and high predicted scene composition change reflecting anticipated physical expressiveness; the crowd-facing camera receives 0.76 for the resolution phase following the peak; the wide-angle stage overview currently being output receives 0.58; and the roving handheld camera receives 0.41 and is suppressed. Fourteen seconds from now, the transition window opens. The directed output generation module 250 detects a natural transition point at sixteen seconds as the lead performer briefly turns away during an instrumental break. The system executes a cut to the lead performer's close-up camera. Two seconds later, the performer delivers the opening line of the final chorus, captured in a tight close-up from the optimal camera position.

### Worked Example 3 - Emergency Response Scenario

Consider a system processing candidate video streams in an emergency response scenario, such as a search and rescue operation, where multiple camera devices are deployed across the operational area, including body-worn cameras on response personnel, aerial cameras on unmanned aerial vehicles, fixed overview cameras at command positions, and vehicle-mounted cameras on response vehicles.

In this scenario, the real-world event does not follow a simple build-up to peak to resolution arc but instead exhibits a more complex phase progression comprising an initial assessment phase, a deployment phase, an active intervention phase representing the peak action, a stabilization phase, and a recovery phase representing the resolution. The temporal state determination module 210 is configured for this event type with a phase classifier trained on historical emergency response recordings, with phase signatures reflecting the specific visual and audio characteristics of each phase.

The anticipated focal point shifts dynamically as the operation progresses - from the command position during the assessment phase, to the deployment routes during the deployment phase, to the intervention site during the active intervention phase. The narrative contribution scoring submodule updates its focal point estimation at each processing cycle to track this dynamic shift, ensuring that the stream selection always directs the directed output video stream toward the camera best positioned to capture the current focal area. This example illustrates that the predictive editorial sequencing system of the present disclosure is not limited to entertainment or sporting event scenarios but is applicable to any real-world event that exhibits recognizable phases of temporal progression.

At each processing cycle, the model update and correction module 225 retrieves the current temporal progression model 222 and extracts the predicted phase duration - the sum of the time elapsed since the most recent phase transition and the predicted time-to-transition. The module also computes the observed elapsed time since the most recent phase transition from the temporal state determination module's phase transition history. The deviation between the predicted and observed durations is computed as the absolute difference between these values, normalized by the predicted phase duration to produce a relative deviation metric.

When the relative deviation metric exceeds the predefined deviation threshold, the model update and correction module 225 flags a model-event misalignment condition and triggers a model recalculation. The recalculation proceeds as follows: the temporal progression model generator 220 is invoked with the updated current temporal state and the updated observed elapsed duration, augmented with the phase duration observations from the current event via the online learning mechanism. The recalculated temporal progression model replaces the prior model, the transition window pre-determination module recalculates the pre-determined transition windows, and the narrative contribution scores are recomputed for the updated windows.

In some embodiments, the model update and correction module 225 further maintains a model confidence decay mechanism in which the confidence of the temporal progression model is progressively reduced as the elapsed time since the most recent model generation increases, reflecting the growing uncertainty of predictions made further in the past. The decayed model confidence is used to widen the pre-determined transition windows over time. When the model confidence falls below a predefined minimum confidence threshold, the module 225 triggers a mandatory model recalculation regardless of whether a deviation has been detected.

In one alternative embodiment, the plurality of event phase classifications is dynamically defined rather than statically prescribed. Rather than operating on a fixed taxonomy defined in advance, the phase classifier 214 learns an unsupervised phase taxonomy from the temporal features of the current event in real time, identifying natural phase boundaries without reference to a predefined phase ontology. This embodiment is particularly suited to event types that are highly variable or novel, for which sufficient historical annotated data may not be available to train a supervised phase classifier. The unsupervised phase taxonomy is represented as a set of cluster centroids in the temporal feature space, each centroid representing a discovered phase, and the current temporal state is determined by assigning the current feature vector to the nearest centroid.

In another alternative embodiment, the temporal progression model is generated from an ensemble of predictive models, each trained on a different subset of the historical event phase progression data or implementing a different predictive architecture. The ensemble produces a distribution of predicted time-to-transition values and predicted forthcoming phases, and the temporal progression model is constructed by aggregating the ensemble outputs. This ensemble approach reduces the variance of the temporal progression model predictions and produces more reliable transition window pre-determination, particularly for event types with high variability in phase duration.

In another alternative embodiment, the narrative contribution scoring incorporates viewer engagement signals derived from real-time feedback from viewers of the directed output video stream, including interaction data such as replay requests, pause events, and sharing actions. Streams that have historically produced high viewer engagement when selected during a given event phase receive a positive adjustment to their predicted narrative contribution score, enabling the system to learn and incorporate viewer preferences.

In another alternative embodiment, the computing platform 120 maintains multiple parallel directed output video streams simultaneously, each targeting a different viewer segment or use case. For example, one directed output stream may be optimized for a broadcast television audience applying conservative transition timing and wide-angle camera selections; a second stream may be optimized for a highlight reel applying aggressive transition timing and close-up selections; and a third stream may be optimized for coaching analysis prioritizing comprehensive coverage of tactical formations. Each parallel output stream maintains its own transition window schedule derived from the same underlying temporal progression model.

In another alternative embodiment, the system operates in a post-event mode in which the candidate video streams have already been recorded and the directed output video stream is generated as a post-production operation. In this embodiment, the temporal state determination module 210 may use a bidirectional temporal analysis window that incorporates both past and future video data, potentially producing more accurate temporal state determinations than are achievable in real-time processing.

In a cloud-based deployment configuration, all functional modules of the computing platform 120 are instantiated on one or more cloud computing instances. The candidate video streams are transmitted from the distributed camera devices to the cloud via the internet or a dedicated wide area network. The cloud-based deployment is well suited to scenarios involving large numbers of candidate video streams from geographically dispersed camera devices, and benefits from elastic scalability enabling the computing platform to dynamically allocate additional processing capacity when the number of candidate streams increases.

In an edge-based deployment configuration, one or more edge computing nodes are deployed at or near the location of the real-world event, physically proximate to the camera devices. The edge nodes perform computationally intensive early-stage processing - specifically the temporal feature extraction and initial quality assessment - on the candidate video streams before transmitting extracted features and metadata to a central computing node for the remaining operations. This architecture reduces the volume of data transmitted over the network and reduces end-to-end processing latency.

In a mobile device deployment configuration, the computing platform 120 is implemented on a single mobile device that simultaneously functions as one of the camera devices and as the processing node. The mobile device receives candidate video streams from other devices via a peer-to-peer wireless network, performs all computing platform operations locally, and generates the directed output video stream on-device. The mobile device deployment is suited to low-latency consumer applications such as automated live streaming from a personal event. Computational efficiency is a primary design consideration in this deployment, and certain operations may be implemented in reduced-complexity versions including lightweight quantized neural network models optimized for mobile inference.

In a hybrid deployment configuration, the computing platform 120 is distributed across a combination of mobile devices, edge computing nodes, and cloud computing instances, with different functional modules allocated to different tiers based on their latency sensitivity, computational intensity, and data locality requirements. In a representative hybrid deployment, video stream reception and temporal feature extraction are performed on edge nodes; phase classification and temporal progression model generation are performed on a cloud instance with access to the full historical data store; and transition window pre-determination and directed output generation are performed on an edge node to minimize transition execution latency. The hybrid configuration is the preferred configuration for professional live broadcast applications.

The one or more processors of the computing platform 120 may comprise general-purpose central processing units, graphics processing units, neural processing units, field-programmable gate arrays, application-specific integrated circuits, or any combination thereof. Neural network inference operations including the phase classifier 214 and the trained predictive model 221 may be accelerated using graphics processing units or dedicated neural processing units where available.

The phase classifier 214 and the trained predictive model 221 are trained offline on a corpus of annotated historical event recordings prior to deployment. The training corpus comprises recordings of multiple instances of each supported event type, annotated by human experts with phase classification labels indicating the temporal phase of the event at each point in each recording. The phase classifier 214 is trained using supervised learning with the annotated phase labels as the target output and the temporal features as input, minimizing the cross-entropy loss between the classifier output distribution and the annotated labels. The trained predictive model 221 is trained using a sequence prediction objective in which the model receives as input the current phase classification, the observed phase duration, and the preceding phase sequence, and is trained to predict the forthcoming phase classification and the time-to-transition.

In some embodiments, transfer learning is applied to adapt the phase classifier and the trained predictive model to a new event type for which limited annotated training data is available, by fine-tuning a model pre-trained on a large multi-event-type corpus. In some embodiments, the models are updated continuously during deployment using the online learning mechanism, incorporating phase progression observations from processed events via incremental learning updates to adapt over time to changes in event characteristics, venue conditions, or capture device profiles.

The present disclosure relates to a system and method for predictive editorial sequencing of a directed video stream based on temporal event phase modelling, as described herein, and further provides inherent and additional technical improvements that enhance specific underlying technologies including distributed video stream processing, temporal machine learning inference systems, real-time multimedia switching architectures, edge-cloud collaborative computing frameworks, and adaptive narrative modelling engines.

In some embodiments, an inherent technical improvement may comprise an adaptive probabilistic phase boundary refinement engine configured to dynamically recalibrate predicted phase transition boundaries using Bayesian sequential updating over sliding temporal windows. A technical problem addressed by this feature may include temporal drift and phase misalignment in real-time event modelling systems, particularly where phase durations exhibit high variance relative to historical statistics. In conventional predictive models, phase transition estimates may degrade in accuracy as event-specific deviations accumulate. In some embodiments, the adaptive probabilistic phase boundary refinement engine may implement a recursive Bayesian filter that treats the predicted time-to-transition as a prior distribution and updates the distribution using newly observed temporal features as likelihood inputs. In some embodiments, the likelihood function may be derived from feature divergence metrics between observed feature vectors and canonical feature signatures for the predicted forthcoming phase. In some embodiments, the recursive update may be implemented using particle filtering, Kalman filtering, unscented Kalman filtering, or variational Bayesian inference. In some embodiments, the refinement engine may maintain multiple hypothesis trajectories corresponding to alternative candidate forthcoming phases and may prune hypotheses based on posterior probability thresholds. This feature may improve the specific technology of temporal machine learning inference systems by reducing cumulative prediction error, narrowing transition window uncertainty bounds, and enabling sub-second precision in anticipatory stream switching.

In some embodiments, an inherent technical improvement may comprise a cross-stream spatiotemporal attention fusion network configured to perform joint feature extraction across heterogeneous candidate video streams prior to phase classification. A technical problem addressed may include independent per-stream feature extraction leading to loss of cross-view correlation information, particularly in multi-camera environments where salient action may span multiple fields of view. In some embodiments, the cross-stream spatiotemporal attention fusion network may implement a transformer-based multi-head attention architecture in which per-stream feature embeddings are concatenated and passed through cross-attention layers that compute inter-stream relational weights. In some embodiments, positional encodings may represent camera spatial coordinates and orientation vectors, enabling geometric context integration. In some embodiments, the architecture may incorporate graph neural network layers representing camera devices as nodes and visibility overlap as weighted edges. In some embodiments, temporal self-attention may be computed over sliding multi-second windows to capture phase evolution patterns across streams. This feature may improve the specific technology of distributed multi-camera video analytics by enabling holistic event-state estimation rather than isolated per-stream inference, thereby increasing robustness in occlusion scenarios and improving predictive alignment accuracy.

In some embodiments, an inherent technical improvement may comprise a low-latency predictive transition pre-buffer orchestration subsystem configured to pre-allocate decode pipelines and GPU memory for anticipated target streams prior to transition window opening. A technical problem addressed may include decode latency spikes and frame discontinuity artifacts when switching to streams that have not been actively decoded. In some embodiments, the subsystem may maintain lightweight background decode threads for top-ranked candidate streams identified by predicted narrative contribution scores. In some embodiments, adaptive bitrate prefetching may be performed for anticipated transition targets using HTTP chunked streaming protocols or real-time transport protocols. In some embodiments, predictive GPU texture allocation may be performed to eliminate memory allocation overhead during transition execution. In some embodiments, the system may dynamically adjust decode resolution of pre-buffered streams to balance resource usage. This feature may improve the specific technology of real-time multimedia switching architectures by reducing transition execution latency, preventing frame drops, and enabling deterministic transition timing within narrow anticipatory windows.

In some embodiments, an inherent technical improvement may comprise a telemetry-augmented anticipatory focal point estimator utilizing predictive kinematic modelling. A technical problem addressed may include inaccurate focal region prediction when relying solely on visual trajectory estimation under partial occlusion or motion blur. In some embodiments, the estimator may fuse positional telemetry vectors with visual optical flow vectors using sensor fusion techniques such as extended Kalman filtering or deep sensor fusion networks. In some embodiments, kinematic state vectors may include position, velocity, acceleration, and predicted collision or convergence points. In some embodiments, anticipated focal zones may be computed using predictive spatial clustering algorithms that detect high-probability convergence regions. In some embodiments, focal region confidence metrics may modulate narrative contribution scoring weights. This feature may improve the specific technology of real-time sports analytics and event tracking systems by providing higher-fidelity anticipation of peak-action loci, thereby improving camera selection precision.

In some embodiments, an inherent technical improvement may comprise a dynamic narrative entropy minimization controller configured to optimize stream sequencing by minimizing predicted informational entropy across successive output segments. A technical problem addressed may include abrupt narrative discontinuities and cognitive overload resulting from non-optimized viewpoint transitions. In some embodiments, the controller may compute Shannon entropy or Kullback–Leibler divergence between feature distributions of consecutive candidate streams. In some embodiments, the optimization objective may minimize entropy subject to constraints on predicted narrative contribution. In some embodiments, reinforcement learning agents may be trained using reward functions incorporating viewer engagement proxies and entropy minimization terms. In some embodiments, Monte Carlo tree search may be used to evaluate alternative transition sequences over multi-phase lookahead horizons. This feature may improve the specific technology of automated video editing engines by introducing mathematically grounded continuity optimization rather than heuristic switching.

In some embodiments, an inherent technical improvement may comprise a phase-aware adaptive model compression framework enabling deployment across heterogeneous compute tiers. A technical problem addressed may include computational overload on edge devices when executing transformer-based phase classifiers. In some embodiments, the framework may implement knowledge distillation from large cloud-trained teacher models to lightweight student models deployed at edge nodes. In some embodiments, dynamic quantization, structured pruning, and sparsity-aware inference acceleration may be applied based on current phase complexity. In some embodiments, phase-specific sub-networks may be activated conditionally to reduce inference overhead during low-complexity phases. This feature may improve the specific technology of edge-cloud collaborative inference systems by maintaining predictive fidelity while reducing latency and energy consumption.

In some embodiments, an additional technical improvement may comprise a self-supervised phase taxonomy evolution module configured to automatically expand or refine event phase classifications using contrastive learning. A technical problem addressed may include rigid predefined phase ontologies that fail to generalize to novel event formats. In some embodiments, the module may generate latent embeddings from temporal feature sequences and cluster embeddings using density-based clustering algorithms. In some embodiments, contrastive predictive coding may be applied to learn discriminative phase boundaries without explicit labels. In some embodiments, newly discovered clusters may be incorporated into the phase classifier via incremental training. This feature may improve the specific technology of adaptive machine learning classification frameworks by enabling unsupervised evolution of temporal taxonomies.

In some embodiments, an additional technical improvement may comprise a neural causal inference engine configured to differentiate causally significant feature transitions from coincidental temporal correlations. A technical problem addressed may include overfitting of predictive models to spurious correlations in high-dimensional multimodal feature spaces. In some embodiments, the engine may construct structural causal models representing relationships between motion intensity, audio energy, telemetry convergence, and phase transitions. In some embodiments, do-calculus interventions may be simulated to evaluate the causal impact of feature perturbations on predicted transitions. In some embodiments, causal regularization loss terms may be integrated into predictive model training. This feature may improve the specific technology of predictive temporal modelling systems by enhancing generalization and robustness to environmental noise.

In some embodiments, an additional technical improvement may comprise a predictive network congestion adaptation layer configured to anticipate bandwidth fluctuations and adjust stream ranking preemptively. A technical problem addressed may include transition failure due to network throughput collapse at the moment of peak action. In some embodiments, recurrent neural networks may model historical bitrate variation patterns to forecast short-term bandwidth availability. In some embodiments, narrative contribution scores may be weighted by predicted transmission reliability. In some embodiments, forward error correction and redundant packet scheduling may be selectively activated for high-priority predicted streams. This feature may improve the specific technology of adaptive video streaming systems by integrating predictive network modelling with editorial decision logic.

In some embodiments, an additional technical improvement may comprise a multi-objective reinforcement learning scheduler for long-horizon editorial planning. A technical problem addressed may include myopic transition optimization that fails to consider downstream phase interactions. In some embodiments, the scheduler may model stream selection as a Markov decision process with states representing temporal phase, focal region probability, and viewer engagement state vectors. In some embodiments, deep Q-networks or proximal policy optimization algorithms may optimize cumulative reward over multiple predicted phase transitions. In some embodiments, simulated event trajectories may be generated using generative temporal models to train the scheduler offline. This feature may improve the specific technology of automated video direction engines by enabling strategic multi-phase optimization rather than single-transition heuristics.

In some embodiments, an additional technical improvement may comprise a privacy-preserving federated phase learning architecture configured to update predictive models across distributed deployments without centralizing raw video data. A technical problem addressed may include regulatory and privacy constraints preventing centralized storage of event recordings. In some embodiments, local edge nodes may compute gradient updates on-device using event-specific data. In some embodiments, secure aggregation protocols and differential privacy noise injection may be applied before transmitting updates to a central coordinator. In some embodiments, homomorphic encryption may protect parameter updates during aggregation. This feature may improve the specific technology of distributed machine learning systems by enabling continuous model refinement while preserving data confidentiality.

In some embodiments, an additional technical improvement may comprise a volumetric scene reconstruction-assisted anticipation module configured to generate real-time 3D spatial reconstructions of the event environment using multi-view stereo or neural radiance field representations. A technical problem addressed may include limited depth awareness when selecting optimal future viewpoints. In some embodiments, depth maps may be estimated per stream using monocular depth networks and fused into a unified volumetric occupancy grid. In some embodiments, neural radiance fields may be trained incrementally to synthesize novel viewpoints. In some embodiments, predicted camera vantage scores may incorporate occlusion probability derived from volumetric models. This feature may improve the specific technology of multi-camera spatial reasoning systems by providing three-dimensional predictive visibility estimation.

In some embodiments, the combination of these inherent and additional technical improvements may collectively transform the predictive editorial sequencing system into an anticipatory, causally aware, resource-adaptive, and privacy-preserving multimedia orchestration platform that improves specific technologies including distributed video analytics, real-time stream switching infrastructures, predictive temporal modelling engines, and edge-cloud machine learning architectures, while addressing non-conventional technical problems such as phase boundary uncertainty, decode latency determinism, cross-stream correlation loss, focal region misprediction, and long-horizon narrative optimization.

The system and method described herein may be implemented in a variety of alternative embodiments that extend or modify the core architecture without departing from the scope of the invention as defined by the appended claims.

What is claimed is:

1. A system for predictive editorial sequencing of a directed video stream, the system comprising:
a communication device configured to receive a plurality of candidate video streams from a plurality of camera devices distributed across multiple locations, the plurality of candidate video streams capturing a common real-world event; and
a computing platform communicatively coupled with the communication device, the computing platform comprising one or more processors and a non-transitory computer-readable memory storing instructions that, when executed by the one or more processors, cause the computing platform to:
determine, from the plurality of candidate video streams, a current temporal state of the common real-world event, the current temporal state being one of a plurality of event phase classifications representing a stage of progression of the common real-world event over time;
generate, based on the current temporal state, a temporal progression model predicting a forthcoming temporal state transition of the common real-world event;
pre-determine, based on the temporal progression model, one or more transition windows during which a transition between candidate video streams of the plurality of candidate video streams is predicted to preserve narrative continuity of the directed video stream; and
generate a directed output video stream by selecting, from the plurality of candidate video streams, a candidate video stream for output and executing stream transitions within the one or more transition windows.

2. A method for predictive editorial sequencing of a directed video stream, the method comprising:
receiving, by a communication device, a plurality of candidate video streams from a plurality of camera devices distributed across multiple locations, the plurality of candidate video streams capturing a common real-world event;
determining, by a computing platform, a current temporal state of the common real-world event from the plurality of candidate video streams, the current temporal state being one of a plurality of event phase classifications representing a stage of progression of the common real-world event over time;
generating, by the computing platform, a temporal progression model predicting a forthcoming temporal state transition of the common real-world event based on the determined current temporal state;
pre-determining, by the computing platform, one or more transition windows during which a transition between candidate video streams of the plurality of candidate video streams is predicted to preserve narrative continuity of the directed video stream, the one or more transition windows being determined based on the temporal progression model; and
generating a directed output video stream by selecting a candidate video stream from the plurality of candidate video streams for output and executing stream transitions within the one or more transition windows.

3. The system of claim 1, wherein the plurality of event phase classifications comprises at least a build-up phase, a peak phase, and a resolution phase, and wherein the computing platform determines the current temporal state by classifying the common real-world event into one of the build-up phase, the peak phase, or the resolution phase based on temporal features extracted from the plurality of candidate video streams.

4. The system of claim 3, wherein the temporal features comprise one or more of motion intensity progression, scene activity density, audio energy envelope, and rate of change of visual composition across the plurality of candidate video streams over a temporal analysis window.

5. The system of claim 1, wherein the generating of the temporal progression model comprises applying a trained predictive model to the current temporal state and to historical event phase progression data, the trained predictive model outputting a predicted time-to-transition value representing an estimated duration until a forthcoming temporal state transition.

6. The system of claim 5, wherein the historical event phase progression data comprises phase duration statistics derived from a plurality of previously observed real-world events of a same event type as the common real-world event.

7. The system of claim 5, wherein the one or more transition windows are defined as time intervals centered on or preceding the predicted time-to-transition value, such that stream transitions are executed before the forthcoming temporal state transition occurs.

8. The system of claim 1, wherein the pre-determining of the one or more transition windows further comprises evaluating, for each candidate video stream, a predicted narrative contribution score representing a degree to which that candidate video stream is predicted to align with the forthcoming temporal state, and wherein the computing platform selects, for output within a transition window, the candidate video stream having the highest predicted narrative contribution score.

9. The system of claim 8, wherein the predicted narrative contribution score for each candidate video stream is computed based on one or more of a predicted motion trajectory, a predicted scene composition change, and a predicted proximity to an anticipated focal point of the common real-world event during the forthcoming temporal state.

10. The system of claim 1, wherein the computing platform is further configured to suppress, prior to a pre-determined transition window, one or more candidate video streams whose predicted content during the forthcoming temporal state is determined to be contextually redundant relative to the currently output video stream.

11. The system of claim 1, wherein the computing platform is further configured to continuously update the temporal progression model as the common real-world event progresses, such that the one or more transition windows are recalculated upon detection of a deviation between the forthcoming temporal state and the current temporal state.

12. The system of claim 11, wherein the deviation is detected by comparing a predicted phase duration derived from the temporal progression model against an observed phase duration computed from the plurality of candidate video streams, and wherein the one or more transition windows are recalculated when the deviation exceeds a predefined threshold.

13. The system of claim 1, wherein the plurality of event phase classifications further comprises one or more intermediate phase classifications representing transitional stages between a build-up phase and a peak phase, or between a peak phase and a resolution phase, and wherein the temporal progression model predicts a sequence of intermediate phase classifications prior to predicting a terminal phase classification.

14. The system of claim 1, wherein the computing platform determines the current temporal state further based on one or more non-visual signals associated with the common real-world event, the one or more non-visual signals comprising at least one of audio signals and telemetry data received in association with one or more of the plurality of candidate video streams.

15. The system of claim 1, wherein the computing platform comprises at least one of a mobile device, an edge or base station, a cloud-based computing system, or a distributed combination thereof.

16. The system of claim 1, wherein the directed output video stream is generated in real time during capture of the common real-world event by the plurality of camera devices.

17. The method of claim 2, wherein the plurality of event phase classifications comprises at least a build-up phase, a peak phase, and a resolution phase, and wherein determining the current temporal state comprises classifying the common real-world event into one of the build-up phase, the peak phase, or the resolution phase based on temporal features extracted from the plurality of candidate video streams.

18. The method of claim 2, wherein the generating of the temporal progression model comprises applying a trained predictive model to the current temporal state and to historical event phase progression data to output a predicted time-to-transition value.

19. The method of claim 2, wherein the pre-determining of the one or more transition windows further comprises computing, for each candidate video stream, a predicted narrative contribution score for the forthcoming temporal state, and selecting, within each transition window, the candidate video stream having the highest predicted narrative contribution score.

20. The method of claim 2, further comprising suppressing, prior to a pre-determined transition window, one or more candidate video streams whose predicted content during the forthcoming temporal state is determined to be contextually redundant relative to the currently output video stream.

21. The method of claim 2, further comprising continuously updating the temporal progression model as the common real-world event progresses, and recalculating the one or more transition windows upon detection of a deviation between the forthcoming temporal state and the current temporal state.
